(19) United States
(12) Patent Application Publication
(10) Pub. No.: US 2017/0297403 A1
(43) Pub. Date: Oct. 19, 2017

(54) STRUCTURE OF ACTIVE MOUNT

(71) Applicant: Hyundai Motor Company, Seoul (KR)

(72) Inventor: Dong-Wook Lee, Yongin (KR)

(21) Appl. No.: 15/366,456

(22) Filed: Dec. 1, 2016

(30) Foreign Application Priority Data
Apr. 19, 2016 (KR) 2016-0047437

(51) Int. Cl. B60G 17/019; B60G 17/016; B60R 16/04; H02N 2/18

(52) U.S. Cl. CPC B60G 17/01941; H02N 2/186; B60G 17/016; B60R 16/04; B60G 2401/10

(57) ABSTRACT

A structure of an active mount is provided. The structure includes a case with an interior that is divided into upper and lower fluid chambers, a sealed hydro fluid flows based on a volume change of the upper fluid chamber due to deformation of an insulator, and flow characteristics of the hydro fluid are varied when power is applied to a driver. The structure further includes a generator that produces electricity based on behavior of the insulator. The generator is disposed within the case and the electricity produced by the generator is applied to the driver. Additionally, the generator autonomously produces electricity based on engine behavior and is mounted within an engine mount and, thus, supply of electricity from the outside is not required.

### CROSS-REFERENCE TO RELATED APPLICATION

This application claims the priority benefit of Korean Patent Application No. 10-2016-0047437, filed on Apr. 19, 2016 in the Korean Intellectual Property Office, the disclosure of which is incorporated herein by reference.

### BACKGROUND

### 1. Field of the Invention

The present invention relates to an active mount (an active control type hydro engine mount) in which, when power is applied, flow characteristics of a hydro fluid are changed to vary damping characteristics, and more particularly, to a structure of an active mount in which a generator that autonomously produces electricity supplied to a driver and a controller that adjusts the supply of electricity are integrated and thus a wire connected to an external device is omitted.

### 2. Description of the Related Art

In general, an engine mount supports a power train (formed by combining an engine and a transmission) in a vehicle, to insulate vibration generated from the power train during idling of the vehicle, and to control behavior of the power train during driving of the vehicle. However, lower dynamic characteristics at a main frequency (in general, about 30˜50 Hz) of engine vibration are advantageous to increase of vibration insulation performance during idling, and a greater damping value at a band of 12˜16 Hz is advantageous to increase of behavior control performance while the vehicle is being driven.

In other words, to enhance both vibration insulation performance during idling and behavior control performance during driving, characteristics of the engine mount need to vary based on driving conditions, and an active mount to satisfy the above conditions is being developed. In general, an active mount is configured with an electronic or vacuum negative pressure-type driver additionally mounted in a hydro engine mount, in which a hydro fluid is sealed, and power is turned on and off based on driving conditions to vary characteristics (e.g., to have low dynamic stiffness during idling and to increase damping performance during driving), as described above.

For active mounts, two types are typically used. In particular, a volume-stiffness type is a type in which behavior of a membrane is controlled, and a bypass type, in which a second flow path to provide communication between an upper fluid chamber and a lower fluid chamber is additionally formed and communication between the upper and lower fluid chambers via the second flow path is controlled. Thereamong, the configuration of a bypass-type active mount will be described with reference to FIG. 1A according to the prior art.

An insulator 10 formed of an elastic material is mounted at the upper part of an interior of a case 12, a diaphragm 14 is combined with the lower end of the interior of the case 12, and a nozzle plate 13 is disposed between the insulator 10 and the diaphragm 14 to divide the inner space of the case 12 into an upper fluid chamber and a lower fluid chamber. A circular flow path is formed in the nozzle plate 13 along the circumference of the nozzle plate 13 thus allowing a sealed hydro fluid to flow to the upper fluid chamber and the lower fluid chamber. When the insulator 10 is elastically deformed by movement of load transmitted from an engine and vibration, the inner volume of the upper fluid chamber is increased or decreased and the hydro fluid is able to flow.

Further, a second flow path to additionally provide communication between the upper fluid chamber and the lower fluid chamber is provided in the nozzle plate 13, and the diaphragm 14 is combined with the upper end of a plunger 20 (or is separated from the plunger 20 according to design) to close the second flow path when the plunger 20 ascends and to open the second flow path when the plunger 20 descends. In the active mount, a lower case 30 provided with a driver installed therein to open and close the second flow path is additionally mounted under the case 12.

In other words, the driver includes the plunger 20 combined with the diaphragm 14 within the lower case 30, a spring 50 mounted to apply elastic force in a direction of raising the plunger 20, and a coil 40 to lower the plunger 20 by electromagnetic force when current is applied thereto. The active mount having the above configuration opens the closed second flow path during idling of the engine and closes the second flow path during driving of the vehicle, and thus varies damping characteristics based on driving conditions.

However, the conventional active mount additionally requires a controller mounted extraneous to the engine mount to vary characteristics of the engine mount based on conditions and to adjust power supply, as exemplarily shown in FIG. 1B according to the prior art. The controller is connected to an engine electronic control unit (ECU) and an alternator to receive the starting state and the revolutions per minute (RPM) state of the engine, and is connected to a battery via a fuse box or connected directly to the battery to receive power supply.

Therefore, in the conventional active mount structure, an additional space to accommodate the controller therein is required, and the controller requires electrical connection to the alternator, the fuse box, the engine ECU, etc., and thus a wiring layout should be considered from the initial stage of vehicle development. In other words, unless application of an active mount is considered from the initial stage of vehicle development, it is difficult to apply the active mount to a vehicle later and considerable loss in specification change according to situations after application inevitably occurs.

### SUMMARY

Therefore, the present invention provides a structure of an active mount which may autonomously produce electricity, sense driving conditions of a vehicle according to amounts of produced electricity and autonomously vary characteristics based on the driving conditions, thus eliminating the need for a separately mounted controller extraneous to the engine mount.

Technical objects to be achieved by the present invention are not limited to those mentioned above, and other objects may be clearly understood by those skilled in the art from the description given below.

In accordance with the present invention, the above and other objects may be accomplished by the provision of a structure of an active mount, in which a nozzle plate may be disposed between an insulator and a diaphragm within a case to divide the interior of the case into an upper fluid chamber and a lower fluid chamber, a sealed hydro fluid may flow based on a change of the volume of the upper fluid chamber, and flow characteristics (e.g., the flow rate, the flow route, the flow speed, etc.) of the hydro fluid may be varied when power is applied to a driver. The structure may further include a generator configured to produce electricity according to behavior of the insulator, wherein the generator may be disposed within the case and electricity produced by the generator may be applied to the driver.

In the present invention, the generator may be combined with or installed in a metal core receiving load of an engine and combined with the insulator. The generator may be electrically connected to the driver through a controller and the controller may be configured to block or permit application of electricity, produced by the generator, to the driver. The controller may further be configured to determine the driving condition of the vehicle according to a predetermined logic by sensing the amount of electricity produced by the generator.

Since the amount of electricity is increased during idling in which vibration having relatively large amplitude occurs and is decreased during driving in which vibration having relatively small amplitude occurs, the controller may be configured to sense the driving condition of the vehicle based on the amount of electricity input to the controller and apply power to the driver based on the determined driving state to vary damping characteristics of the overall engine mount. In other words, in the active engine mount of the present invention, the controller may be configured to transmit electricity produced by the generator to the driver based on the driving condition of the vehicle without requiring a separate external controller or power supply device and thus the driver may be operated without installation of separate wiring (extending to the outside of the engine mount).

Further, the controller may include a storage battery installed therein to store electricity produced by the generator. A chamber may be provided within the core and the generator may be installed within the chamber, the generator may have a cantilever structure with a first end fixed to the inner wall of the chamber and a second end operating as a vibrating free end, and piezoelectric elements, configured to generate voltage when tension and compression of the piezoelectric elements occur as the free end vibrates, may be installed within the generator. Further, a mass having a designated mass may be mounted at the free end of the cantilever structure to increase vertical displacement occurring at the free end.

### BRIEF DESCRIPTION OF THE DRAWINGS

The above and other objects, features and other advantages of the present invention will be more clearly understood from the following detailed description taken in conjunction with the accompanying drawings, in which:

FIG. 1A is a cross-sectional view of a conventional active mount according to the prior art;

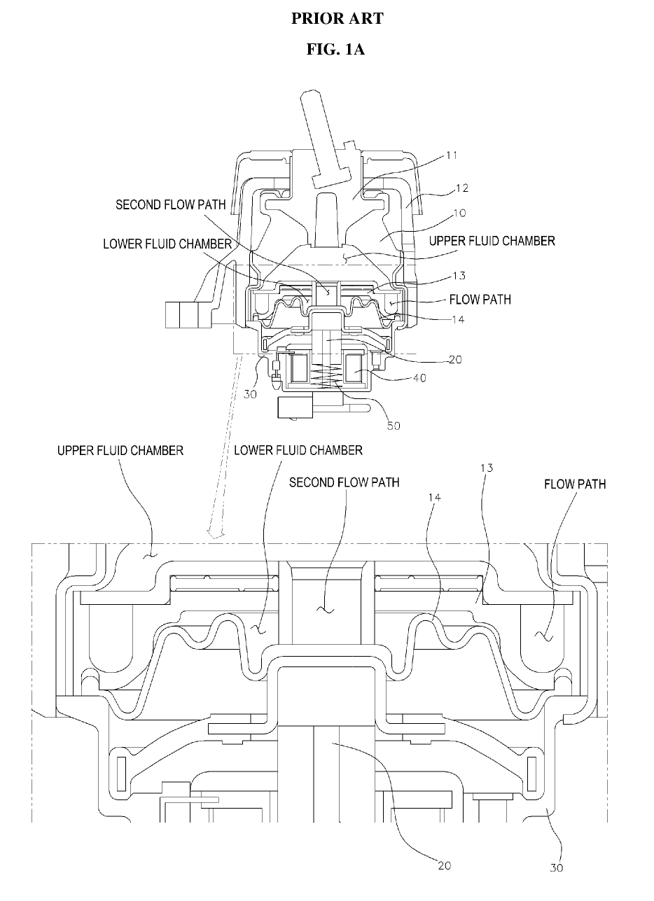

FIG. 1B is a view illustrating a wiring state of a controller installed at the outside, respectively connected to a fuse box, an engine ECU and an alternator, when the conventional active mount is mounted according to the prior art;

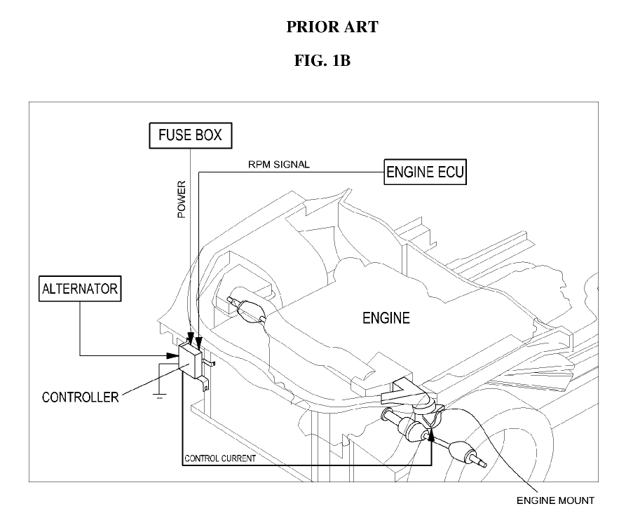

FIG. 2 is a view illustrating a generator mounted in a core in accordance with an exemplary embodiment of the present invention;

FIG. 3 is a detailed view illustrating the generator mounted in the core of FIG. 2 in accordance with an exemplary embodiment of the present invention;

FIG. 4 is a graph comparing an amount of electricity produced during idling of an engine and an amount of electricity produced during driving in accordance with an exemplary embodiment of the present invention; and

FIGS. 5A and 5B are block diaphragms respectively illustrating a conventional configuration and a configuration in accordance with the present invention in a structure in which power is applied to a driver (more particularly, a coil included in the driver).

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, the present invention will be described in detail with reference to the accompanying drawings to allow those skilled in the art to easily practice the present invention. While the invention will be described in conjunction with exemplary embodiments, it will be understood that the present description is not intended to limit the invention to those exemplary embodiments.

In order to clearly describe the present invention, a statement of parts which are not related with the description will be omitted and, in the specification, some parts which are substantially the same as or similar to other parts are denoted by the same reference numerals even though they are depicted in different drawings. Further, the terms or words used in the specification and claims of the present invention are not interpreted using typical or dictionary limited meanings, and are constructed as meanings and concepts conforming to the technical sprit of the present invention based on the principle that the inventors can appropriately define the concepts of the terms to explain the present invention in the best manner.

The present invention relates to an active mount in which a space formed between an insulator 10 and a diaphragm 14 mounted within a case 12 may be divided into an upper fluid chamber and a lower fluid chamber, a sealed hydro fluid may flow through a flow path (and/or a second flow path) based on a change in the volume of the upper fluid chamber, and flow characteristics of the hydro fluid may be varied when power is applied to a driver 300. Hereinafter, an exemplary embodiment of the present invention will be described in more detail.

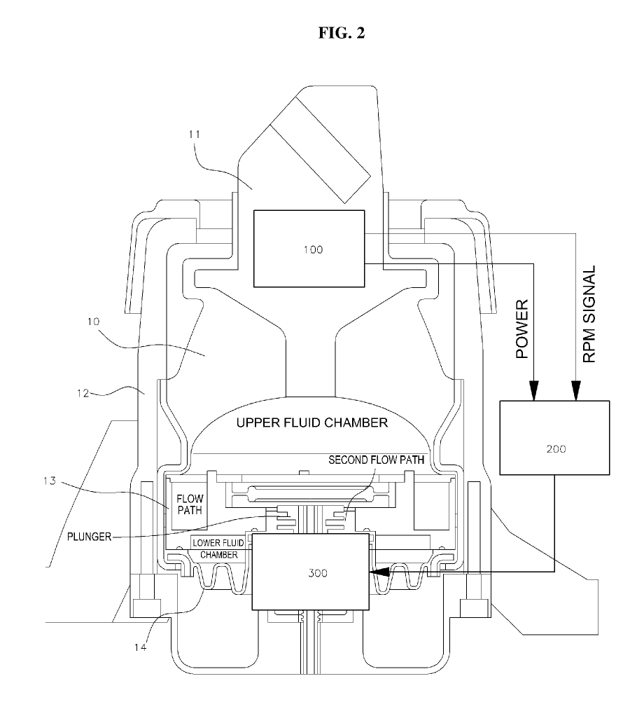

As exemplarily shown in FIG. 2, in the same manner as a conventional active mount, in an active mount in accordance with an exemplary embodiment of the present invention, an insulator 10 formed of an elastic material may be mounted at the upper part of the interior of a case 12, a diaphragm 14 may be combined with the lower end of the interior of the case 12, and a nozzle plate 13 may be mounted between the insulator 10 and the diaphragm 14 to divide the interior space of the case 12 into an upper fluid chamber and a lower fluid chamber.

Further, a circular flow path may be formed in the nozzle plate 13 along the circumference of the nozzle plate 13 to allow a sealed hydro fluid (e.g., the flow path is sealed) to flow to the upper fluid chamber and the lower fluid chamber. When the insulator 10 is elastically deformed by movement of load transmitted from an engine and vibration, the inner volume of the upper fluid chamber is increased or decreased and thus, the hydro fluid may flow.

In particular, a second flow path to additionally provide fluid communication between the upper fluid chamber and the lower fluid chamber may be provided in the nozzle plate 13 (or, in the case of a volume stiffness-type active mount, a membrane may be mounted), and a driver 300 including a plunger, a coil, a spring, etc. may be configured to close or open the second flow path (in the similar manner to a conventional structure) (or, in the case of a volume stiffness-type active mount, configured to control behavior of a membrane generating vibration when the hydro fluid flows). In other words, when power is applied to the driver 300, the driver 300 may be operated to vary the flow route of the hydro fluid or to change the flow speed or flow rate of the hydro fluid to adjust damping characteristics.

Additionally, the active mount of the present invention may include a generator 100 configured to produce electricity during behavior of the insulator 10. The generator 100 may be disposed within the case 12 and the produced electricity may be applied to the driver 300. In the exemplary embodiment of the present invention, the generator 100 may be mounted in a core 11 formed of a metal, which receives load of an engine and may be combined with the insulator 10.

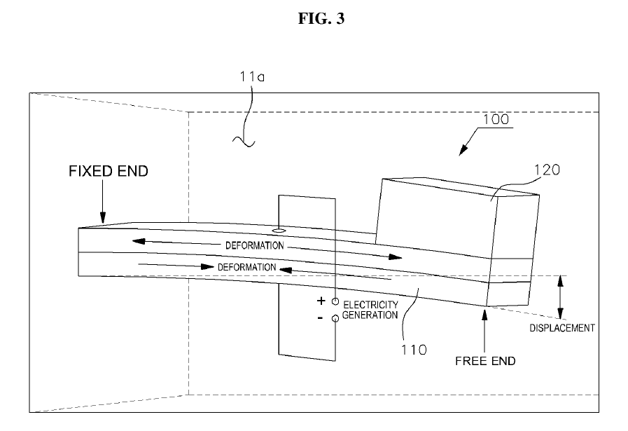

In particular, as exemplarily shown in FIG. 3, a chamber 11a having a designated size (forming an inner space) may be disposed within the core 11 and the generator 100 may be mounted within the chamber 11a. The generator 100 may have a cantilever structure 110 with a first end fixed to the inner wall of the chamber 11a and a second end of which is a free end which may vibrate, and piezoelectric elements may be installed in the generator 100. Therefore, as the free end of the cantilever structure 110 vibrates, tension and compression of the piezoelectric elements occur and thus generates voltage.

Moreover, production of electricity using the cantilever principle will be described in more detail. When tensile force or compression stress is applied to the piezoelectric elements, voltage is generated in a polarizing direction. When two piezoelectric elements are disposed in parallel and an electrode is formed therebetween, the generated voltage may be transmitted to the exterior. An electricity generation method using the above principle is applied to pickup of record, an acceleration sensor, knocking sensor, etc., and a more detailed configuration and operating principle thereof will be omitted.

Further, to increase vertical displacement occurring at the free end of the generator 100, a mass 120 having a designated mass may be mounted at the free end of the cantilever structure 110. As described above, the generator 100 may be electrically connected to the driver 300 via the controller 200 and the controller 200 may be configured to block or permit application of electricity, produced by the generator 100, to the driver 300 (e.g., block or permit the transmission of the electricity to the driver). The controller 200 may be separately disposed either within or extraneous to the case 12 of the engine mount, as exemplarily shown in FIG. 2, or be integrated with any one of the generator 100 or the driver 300, and the controller 200 may be configured to sense the amount of electricity produced by the generator 100 and determine the driving condition of the vehicle according to a predetermined logic.

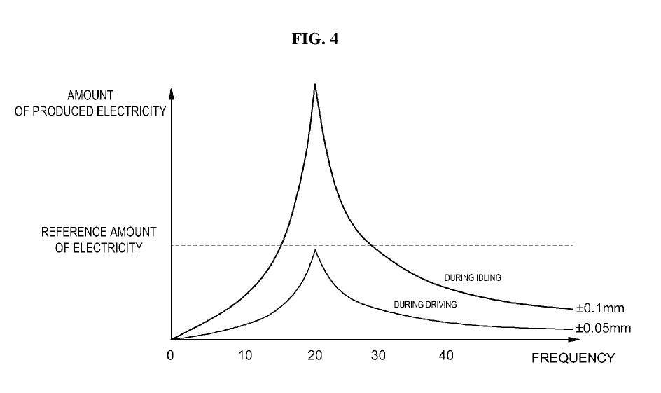

As exemplarily shown in FIG. 4, vibration having relatively large amplitude occurs and the amount of produced electricity increases during idling in which the RPM of the engine is low, and the amplitude of vibration is reduced and the amount of produced electricity decreases during driving of the vehicle in which the RPM of the engine is high. Therefore, the controller 200 may be configured to determine the driving state of the vehicle based on the amount of produced electricity input to the controller 200, and apply power to the driver 300 based on the determined driving state to vary damping characteristics of the overall engine mount.

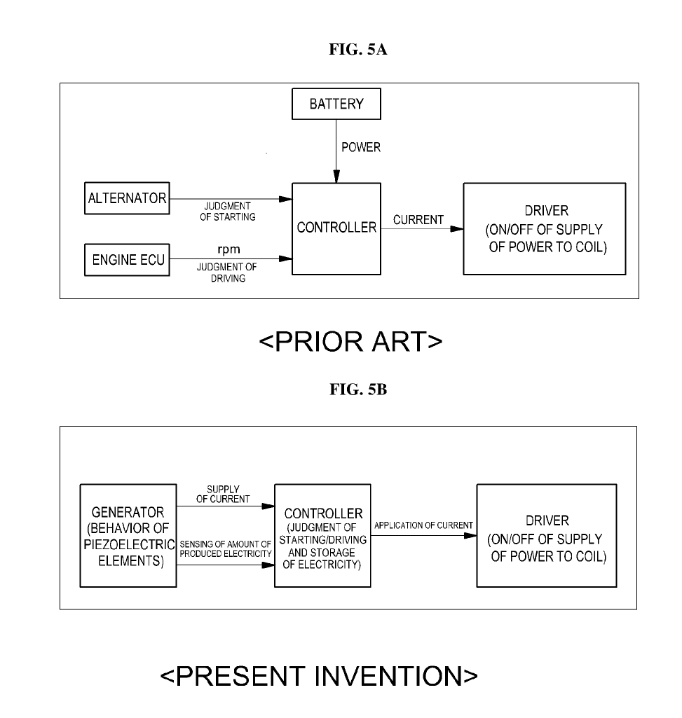

As exemplarily shown in FIG. 5A, in the conventional active mount configuration, since power is supplied from an external battery, the starting state and driving condition of a vehicle are determined using the alternator and the engine ECU and then the controller applies power to a driver, wiring becomes complex and a space to install the controller extraneous to the active mount is required. On the other hand, as exemplarily shown in FIG. 5B, in the active mount configuration in accordance with an exemplary embodiment the present invention, since the controller 200 may be configured to receive electricity from the generator 100 and simultaneously sense the driving condition of the vehicle by sensing the amount of produced electricity, the driver 300 may be operated without installation of separate wiring (extending to the outside of the engine mount). For reference, the controller 200 may include a storage battery installed therein to store electricity produced by the generator 100 and may thus supply electricity to the driver 300 only as required.

Accordingly, as is apparent from the above description, in a structure of an active mount in accordance with the present invention, a generator 100 configured to autonomously produce electricity based on behavior of an engine may be mounted within an engine mount and, thus, supply of electricity from the outside may be omitted, conventional constraint conditions due to wiring may be eliminated and the active mount is applicable to various types of vehicles. Further, in the active mount structure in accordance with the present invention, a controller 200 may be mounted in or combined with the engine mount and thus, an assembly process may be simplified.

Further, the controller 200 may be configured to detect the driving state of a vehicle by sensing the amount of electricity produced by the generator 100, thus eliminating the need for wiring with a separate external device, and the amount of produced electricity sensed by the controller 200 is usable as a signal to estimate the RPM of the vehicle and thus the controller 200 may be used as a sensor to provide RPM information to surrounding electronic devices. Moreover, a mass 120 having a designated mass may be mounted at the free end of a cantilever structure of the generator and may thus increase behavior of piezoelectric elements, thereby increasing the amount of electricity.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A structure of an active mount, comprising:
a case having an interior divided into an upper fluid chamber and a lower fluid chamber, wherein a sealed hydro fluid flows according to a volume change of the upper fluid chamber due to deformation of an insulator, and flow characteristics of the hydro fluid are varied when power is applied to a driver; and
a generator configured to produce electricity based on behavior of the insulator,
wherein the generator is disposed within the case and the electricity produced by the generator is applied to the driver.

2. The structure according to claim 1, wherein the generator is combined with a metal core receiving load of an engine and combined with the insulator.

3. The structure according to claim 2, wherein the generator is electrically connected to the driver via a controller and the controller is configured to block or permit transmission of the electricity, produced by the generator, to the driver.

4. The structure according to claim 3, wherein the controller is configured to determine the driving condition of the vehicle based on a predetermined logic by sensing the amount of electricity produced by the generator.

5. The structure according to claim 3, wherein the controller includes a storage battery installed therein to store electricity produced by the generator.

6. The structure according to claim 4, further comprising:
a chamber is disposed within the core and the generator is installed within the chamber, wherein the generator has a cantilever structure with a first end fixed to an inner wall of the chamber and a second end operating as a vibrating free end; and
piezoelectric elements installed within the generator and configured to generate voltage when tension and compression of the piezoelectric elements occur as the free end vibrates.

7. The structure according to claim 6, wherein a mass having a designated mass is mounted at the free end of the cantilever structure.
